(19) United States
(12) Patent Application Publication
(10) Pub. No.: US 2020/0191067 A1
(43) Pub. Date: Jun. 18, 2020

(54) DEVICE FOR THC REDUCING OF EXHAUST GAS IN CNG-DIESEL DUAL FUEL ENGINE SYSTEM

(71) Applicant: RO CO., LTD., Gyeonggi-do (KR)

(72) Inventors: Joo Chang PARK, Seoul (KR); Sung Cheol KIM, Gyeonggi-do (KR)

(21) Appl. No.: 16/439,858

(22) Filed: Jun. 13, 2019

(30) Foreign Application Priority Data
Dec. 17, 2018 (KR) 10-2018-0163066

(51) Int. Cl. F02D 13/02; F01N 3/10

(52) U.S. Cl. CPC F02D 13/0246; F01N 3/103; F02D 2200/06; F02D 2200/023; F01N 2430/00; F02D 2013/0296

(57) ABSTRACT

A device for reducing total hydrocarbon (THC) contained in exhaust gas in a CNG-diesel dual fuel engine system, includes: an engine providing power for the diesel and outputting exhaust gas due to operation; a MOC (Methane Oxidation Catalyst) oxidizing and discharging CH₄ contained in exhaust gas discharged from the engine; an exhaust valve disposed in a pipe connecting the rear end of the engine and the front end of the MOC, and discharging the exhaust gas produced by the engine; a first temperature sensor disposed at the front end of the exhaust valve and measuring the temperature of exhaust gas coming from the engine; a second temperature sensor disposed at the rear end of the exhaust valve and measuring the exhaust gas discharged from the exhaust valve and flowing into the MOC; and an exhaust valve control unit increasing the temperature of exhaust gas flowing into the MOC.

### CROSS REFERENCE

The present application claims priority to Korean Patent Application No. 10-2018-0163066, filed 17 Dec. 2018, the entire contents of which is incorporated herein for all purposes by this reference.

### BACKGROUND

The present invention relates to a technology being able to reduce and discharge total hydrocarbon (THC) contained in exhaust gas by adjusting the temperature of exhaust gas flowing in methane oxidation catalyst (MOC) by controlling an exhaust valve in a dual fuel engine system that uses a mixture of compressed natural gas (CNG) and diesel as engine fuel.

As the interest in the global environment grows, the harmful substances emitted by automobiles are known as the main fact in the deterioration of air quality in urban areas.

Particularly, the diesel engine provided in the diesel vehicle is advantageous in that it can obtain a larger output than the gasoline engine or the gas (LPG, CNG, etc.) engine. However, the diesel engine has a greater exhaust gas emission than the gasoline engine or the gas engine. There is a problem of environmental pollution caused by NOx, SOx, THC, or the like, which are mixed with the exhaust gas to be discharged.

Recently, in order to solve the disadvantage that the diesel vehicle is economically more expensive than gas (LPG, LNG) one and the emission problem of harmful substances, studies on the diesel-gas dual fuel engine, in that the diesel fuel and the gas fuel are mixed to be driven, have been actively progressed.

The dual fuel system having the diesel-gas dual fuel engine applies the sensor signals input and output from an electronic control unit (ECU) of the diesel engine as it is and includes an electronic control device for a separate gas fuel. That is, it is possible to convert the diesel engine into the diesel-gas dual fuel engine without changing the structure of the diesel engine.

In addition, when the dual fuel system is installed in the diesel vehicle, the efficiency of energy use such as a fuel cost reduction of 25% or more compared with the conventional diesel engine can be improved and the harmful exhaust gas and the exhaust gas such as carbon dioxide etc. can be drastically reduced.

Particularly, in the case of diesel vehicles, regulations on NOx in harmful substances contained in the exhaust gas have been strengthened. In order to reduce the harmful substances of the exhaust gas, the diesel vehicle is equipped with a post-treatment device including DOC, DPF, SCR and AOC.

Here, the Diesel Oxidation Catalyst (DOC) serves to lower the concentration of fume, CO and HC, the diesel Particulate Filter (DPF) serves to collect (separation and collection of minor elements in mattes) and reheat PM, which is the fine soot particle, to be removed, the Selective Catalyst Reduction (SCR) performs a function of reducing nitrogen oxide (NOx) as well as carbon monoxide generated in a large amount in the engine, and the Ammonia Oxidation Catalyst (AOC) performs a function of oxidizing the ammonia of the exhaust gas.

On the other hand, when the diesel vehicle is equipped with the dual fuel system, the diesel vehicle can be operated in a dual fuel mode using a mixture of diesel fuel and gaseous fuel.

FIG. 1 is a graph showing the results of analyzing the components of the exhaust gas measured in the front and rear portions of the post-treatment device when the diesel vehicle equipped with the dual fuel system is operated in the diesel mode and the dual fuel mode by means of the present inventor.

FIG. 1A shows the results of analyzing the components of the exhaust gas in the dual fuel mode and FIG. 1B shows the results of analyzing the components of the exhaust gas in the diesel mode. FIG. 1 shows the results of analyzing the components of the exhaust gas (Engine-out) output from an engine and the exhaust gas components at a DOC output terminal (DOC-out), a DPF output terminal (PDF-out), and an AOC output terminal (AOC-out).

According to the results of the measurement of FIG. 1, the amount of NOx of the exhaust gas measured at the end of the engine and the front end of the post-treatment device in dual fuel operation is reduced by about 30% in comparison with the diesel operation, while THC is increased by about 6,539% and CO is increased by about 893%.

Meanwhile, In the WHSC mode, the exhaust gas emission standards of EURO 6 exhaust gas are 0.4 g/kWh for NOx, 0.13 g/kWh for THC, and 1.5 g/kWh for CO. As a result of experiment in the exhaust gas system identical to the diesel at the target engine test mode during CNG-diesel dual fuel operation, the exhaust gas components are NOx: 0.0886 g/kWh, THC: 12.85 g/kWh and CO: 0.0078 g/kWh at the end of AOC. In case of Co, about 99% is reduced after passing DOC. Also, in case of NOx, about 98% is reduced after passing SCR.

However, during the dual fuel operation, THC is discharged to the level of about 980 times at the end of the DOC in comparison with diesel operation and it can be understood that the DOC of the conventional diesel engine does not satisfy the regulatory condition for the THC.

THC (total hydrocarbon) is a generic name of organic compounds measured by hydrogen flame ionization detection method. It is classified into methane-based hydrocarbons and non-methane-based hydrocarbons. In the dual fuel engines, more than 90% of THC contained in vehicle exhaust gas is composed of CH₄.

In other words, while the CNG-diesel dual fuel engine maintains excellent thermal efficiency and torque performance of the diesel engine, it can greatly improve the PM and NOx emissions emitted from the conventional diesel engine. However, there is a problem in that the methane emissions thereof is 66 times in comparison with the diesel engine owing to the methane (CH₄), which is the main component of the CNG fuel. Accordingly, it is necessary to reduce the methane emissions. In particular, since the global warming index of methane is 21 times larger than that of carbon dioxide, it is gradually regarded as essential reduction targets.

Accordingly, in order to reduce CH4, a method of providing a methane oxidation catalyst (MOC) in the exhaust gas post-treatment device may be proposed. MOC is a post-treatment device installed to reduce CH4 of exhaust gas in gas vehicles such as CNG and LPG etc.

FIG. 2 is a graph showing the results of an experiment of measuring the THC emission amount of a diesel vehicle equipped with a dual fuel system by means of the present inventors, FIG. 2A is a graph showing the results of an experiment of measuring the engine load (purple color) and the engine RPM (blue color) over time from startup in a state that MOC is mounted on the rear end of the engine, and FIG. 2B is a graph showing the results of an experiment of measuring THC emissions according to presence or absence of MOC in the dual fuel mode.

Referring to FIG. 2B, a section corresponding to a low engine load factor, which is an initial section (red box) after startup shown in FIG. 2A shows a relatively large amount of THC emission.

Further, according to FIG. 2B, since the difference between the case of mounting the MOC and the case of not mounting the MOC in the interval of 200 to 600 sec (the red box section of FIG. 2A is minor, it can be seen that the THC reduction efficiency performance of MOC is low.

In other words, the total hydrocarbon (THC) of the exhaust gas does not satisfy the exhaust gas regulating condition in the CNG-diesel fuel supply system in a specific section. Accordingly, in order to activate CNG-diesel fuel supply system having a good reduction effect of harmful substances, it is necessary to reduce the total hydrocarbon (THC) contained in the exhaust gas.

Patent Literature 1: Korean Patent No. 10-1628387 (Title: Butterfly valve device for vehicle engines; Jun. 1,2016)

### SUMMARY OF THE INVENTION

The present invention has been made in consideration of the circumstances described above and an object of the present invention is to provide a device for reducing total hydrocarbon (THC) contained in exhaust gas in a CNG-diesel dual fuel engine system, the device being able to reduce and discharge the THC contained in exhaust gas to satisfy EURO 6 by sending exhaust gas into a MOC with the temperature of the exhaust gas maintained at a predetermined level or higher by controlling an exhaust gas.

According to an aspect of the invention to achieve the object described above, there is provided a device for THC reducing of exhaust gas in CNG-diesel dual fuel engine system that enables CNG (Compressed Natural Gas) and diesel to be used as fuel of a diesel engine by co-firing them in a diesel vehicle equipped with a CNG supply unit for an aftermarket, the device including: an engine providing power for the diesel and outputting exhaust gas due to operation; a MOC (Methane Oxidation Catalyst) oxidizing and discharging CH₄ contained in exhaust gas discharged from the engine; an exhaust valve disposed in a pipe connecting the rear end of the engine and the front end of the MOC, and discharging the exhaust gas produced by the engine; a first temperature sensor disposed at the front end of the exhaust valve and measuring the temperature of exhaust gas coming from the engine; a second temperature sensor disposed at the rear end of the exhaust valve and measuring the exhaust gas discharged from the exhaust valve and flowing into the MOC; and an exhaust valve control unit increasing the temperature of exhaust gas flowing into the MOC by decreasing an opening angle of the exhaust valve such that an exhaust gas discharge passage of the pipe is narrowed when output temperature of the second temperature sensor is less than a predetermined reference output temperature by monitoring the output temperature with exhaust gas being discharged from the engine after the engine is started; and enlarging the exhaust gas discharge passage of the pipe by increasing the opening angle of the exhaust valve when input temperature of the first temperature sensor is a predetermined reference input temperature or higher by monitoring the input temperature.

Preferably, when the engine of the vehicle is started, the exhaust valve control unit first repeats monitoring output temperature of the second temperature sensor, controlling the exhaust valve to increase the opening angle of the exhaust valve by monitoring input temperature of the first temperature sensor with the opening angle of the exhaust valve decreased in accordance with output temperature of the second temperature sensor, and monitoring output temperature of the second temperature sensor with the opening angle of the exhaust valve increased by the first temperature.

Preferably, the reference input temperature is set higher than the reference output temperature, and the exhaust valve controller adjusts the opening angle of the exhaust valve such that exhaust gas with a temperature of 400° C. or higher flows into a post-processing unit.

Preferably, the MOC is composed of a first MOC and a second MOC sequentially disposed behind the engine, the first MOC increases exhaust gas in temperature using reaction with CH₄ contained in exhaust gas discharged from the engine and outputs to the second MOC, and the second MOC performs a function that reduces CH₄ contained in exhaust gas to satisfy regulations.

Preferably, an integral processing unit that reduces noxious substances contained in exhaust gas and discharges the exhaust gas is disposed behind the MOC and a third temperature sensor measuring the temperature of exhaust gas flowing into the integral processing unit is additionally disposed ahead of the integral processing unit, and the exhaust valve control unit transmits temperature information provided from the third temperature sensor while controlling the opening angle of the exhaust valve on the basis of monitoring the first temperature sensor and the second temperature sensor, and transmits temperature information within a predetermined reference temperature range to a diesel ECU when the temperature provided from the third temperature sensor is the reference temperature range or higher.

Preferably, the exhaust valve control unit receives engine load rate information by communicating with a diesel ECU (electronic control unit), and controls the opening angle of the exhaust valve on the basis of monitoring the first temperature sensor and the second temperature sensor only when the engine load rate is less than a predetermined reference level.

Preferably, the device includes a CNG control unit controlling CNG spray from the engine and transmitting CNG spray information to the exhaust valve control unit, wherein the exhaust valve control unit controls the opening angle of the exhaust valve on the basis of monitoring the first temperature sensor and the second temperature sensor only when determining that it is a co-firing mode on the basis of the CNG spray information provided from the CNG control unit.

Preferably, the exhaust valve control unit monitors input temperature of the first temperature sensor when receiving a valve opening signal from the diesel ECU with the exhaust valve closed, and monitors output temperature of the second temperature sensor when receiving a valve closing signal from the diesel ECU with the exhaust valve open.

Preferably, the exhaust valve control unit differently sets a reference input temperature and a reference output temperature in diesel mode and a co-firing mode, and controls the exhaust valve on the basis of the predetermined reference input temperature and the reference output temperature in correspondence to the operation mode received by communicating with the diesel ECU.

Preferably, the exhaust valve includes a flap valve disposed in a pipe between the engine and the MOC, and a motor adjusting the position of the flap valve, and adjusts the temperature of exhaust gas by adjusting the amount of exhaust gas supplied to the MOC through the pipe in accordance with the position of the flap valve.

### BRIEF DESCRIPTION OF THE DRAWINGS

The above and other objects, features and advantages of the present invention will be more apparent from the following detailed description taken in conjunction with the accompanying drawings, in which:

FIGS. 1A and 1B are graphs showing the results of analyzing the components of the exhaust gas measured in the front and rear portions of the post-treatment device when the diesel vehicle equipped with the dual fuel system is operated in the diesel mode and the dual fuel mode by means of the present inventor;

FIGS. 2A and 2B are graphs showing the results of an experiment of measuring the THC emission amount of a diesel vehicle equipped with a dual fuel system by means of the present inventors;

FIGS. 3A and 3B are graphs showing the result of test of the oxidation characteristic according to temperature of a MOC by the inventor(s), in which the oxidation performance results of several MOCs and DOCs having different catalytic conditions are shown;

FIG. 4 is a view schematically showing main components of a CNG-diesel dual fuel engine system having a THC reduction function according to a first embodiment of the present invention;

FIGS. 5 and 6 are exemplary views for illustrating the structure of the exhaust valve (400) shown in FIG. 4;

FIG. 7 is a block configuration diagram separately showing the inner components of the exhaust valve control unit (800) shown in FIG. 4;

FIGS. 8A and 8B are diagrams for explaining a control method of the opening angle of the exhaust valve (400) at the control unit (840) shown in FIG. 7; and

FIG. 9 is a diagram for explaining a method of reducing THC in a CNG-diesel dual fuel engine system according to the present invention.

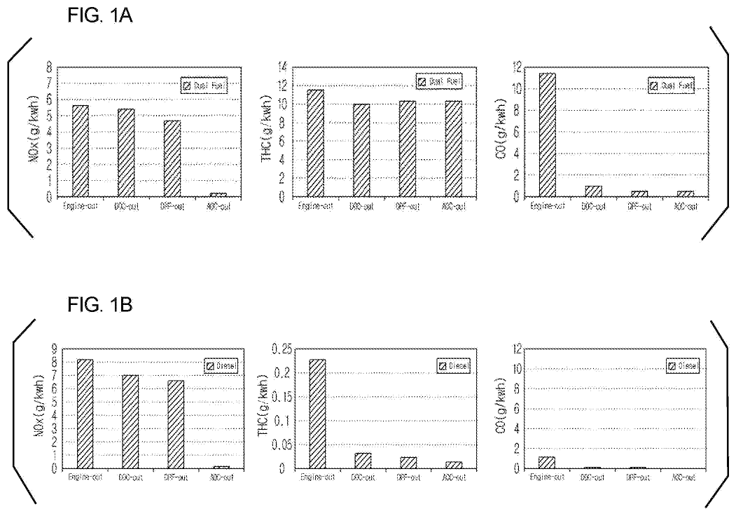

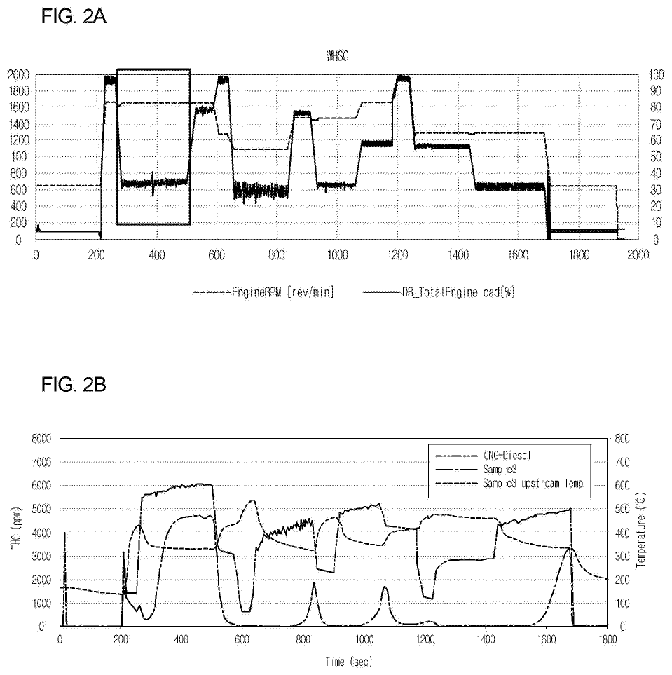

### DETAILED DESCRIPTION OF THE PREFERRED EMBODIMENT

Since the description of the present invention is a mere embodiment for structural and functional description m, it must not be interpreted that the scope of the present invention is limited by the embodiments described in the text. That is, since the embodiments can be variously changed and have various forms, it should be understood that the scope of the invention includes the equivalents for realizing the technical concept. Also, since the specific embodiments do not include all objects and effects presented by the present invention, the scope of the present invention is not limited by them.

Unless differently defined, all the terms used here including technical or scientific terms have the same meaning with what is generally understood by one who has common knowledge in the technical field that this invention belongs to. The terms such as those defined in the dictionary commonly used will be interpreted to have the meanings matching with the meanings in the context of the related technologies. Unless clearly defined in this application, they are not interpreted as ideal or excessively formal meanings.

The present invention is applied to a CNG-diesel dual fuel engine system that makes it possible to use CNG and diesel as the fuel of a diesel engine by co-firing the CNG and the diesel in a diesel vehicle equipped with an automotive CNG supply unit for an aftermarket. The present invention is characterized by enabling improvement of a reaction rate of THC in a MOC even in a low-temperature low-load period by sending exhaust gas from an engine into the MOC with the temperature of the exhaust gas maintained at a predetermined level or higher in order to reduce noxious substances, particularly, total hydrocarbon (hereafter, referred to as THC) contained in the exhaust gas.

First, the inventor(s) has found out the characteristic that various MOC oxidation catalysts have similar oxidation characteristic according to temperature as the result of the research about oxidation performance CH₄ in a MOC.

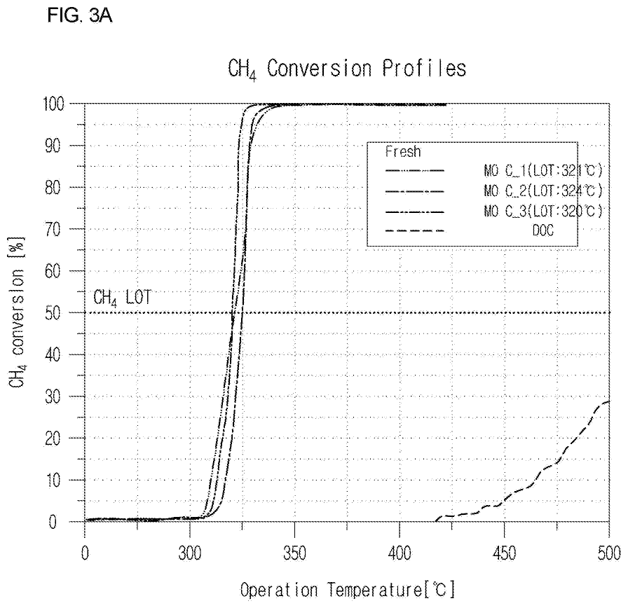

FIGS. 3A and 3B show the result of test of the oxidation characteristic according to temperature of a MOC by the inventor(s), in which the oxidation performance results of several MOCs and DOCs having different catalytic conditions are shown. In FIG. 3A is an oxidation performance result according to temperature in the early stage of a test of a MOC, and 3B is an oxidation performance result according to temperature after aging under predetermined conditions of the MOC, and in this test, aging was performed at (800)° C. for 16 hours.

It can be seen from FIGS. 3A and 3B that, fundamentally, the MOCs have excellent CH₄ reduction performance in comparison to the DOCs disposed in an existing post-processing unit.

Further, it can be seen that most MOCs show CH₄ oxidation rate of 90% or more at 350° C. or higher in 3A and CH₄ oxidation rate of 80% or more at (400)° C. or higher in 3B.

The present invention has been made to improve the CH₄ oxidation performance of a MOC by controlling the temperature of exhaust gas flowing into the MOC using this oxidation characteristic according to temperature of MOCs.

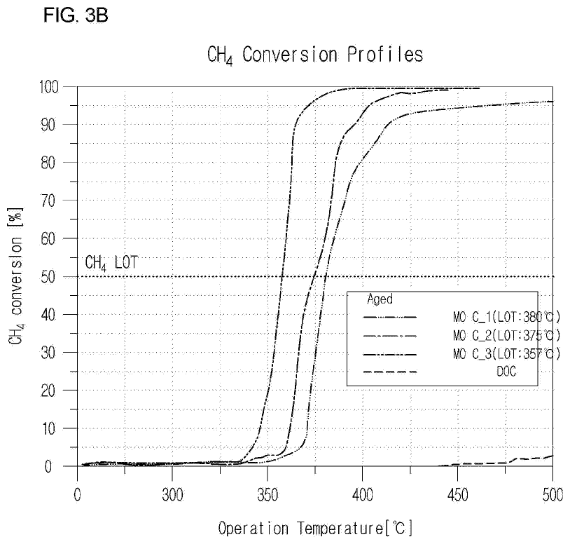

FIG. 4 is a view schematically showing main components of a CNG-diesel dual fuel engine system having a THC reduction function according to a first embodiment of the present invention.

Referring to FIG. 4, the CNG-diesel dual fuel engine system having a THC reduction function according to the present invention includes an engine (100), a diesel ECU (electronic control unit) (200), a CNG control unit (300), an exhaust valve (400), a post-processing unit (500), a first temperature sensor (600), a second temperature sensor (700), and an exhaust valve control unit (800).

The engine (100) is controlled by the diesel ECU (200) and the CNG control unit (300) to provide power to a vehicle by burning fuel that is supplied from a diesel supply unit (not shown) and a CNG supply unit (not shown). Exhaust gas that is produced by the operation of the engine (100) flows into the post-processing unit (500) through a pipe (1), depending on whether the exhaust valve (400) is opened.

The diesel ECU (200) performs general control on a diesel vehicle, and particularly, is connected with various devices and sensors in a vehicle, thereby determining the state of the vehicle and controlling the operations of the connected devices on the basis of the determination.

Further, the diesel ECU (200) outputs information about the engine operation of the diesel vehicle to the CNG control unit (300) and the exhaust valve control unit (800). The diesel ECU (200) performs CAN (controller area network) communication with the CNG control unit (300) and the exhaust valve control unit (800).

In particular, the diesel ECU (200) provides various items of engine state information including an engine load rate, an engine starting state, and a valve control signal, which are provided from the engine (100), to the exhaust valve control unit (800).

The CNG control unit (300) generates a spray control signal for spraying CNG, and on the basis of this signal, sprays CNG to the engine (100) and provides CNG spray information to the exhaust valve control unit (800). A fuel supply mode, which is set on the basis of whether CNG is sprayed to the engine (100), may be freely set by a driver or may be automatically set on the basis of the driving state of a driver or the engine state of the vehicle.

The exhaust valve (400) is disposed between the engine (100) and the post-processing unit (500) and discharges or not the fuel gas generated by the engine (100), that is, exhaust gas. The exhaust valve (400) fundamentally includes a flap valve disposed in the path for discharging exhaust gas and a motor that opens/closes the flap valve. That is, a flap is repeatedly opened and closed in the flap valve by the motor.

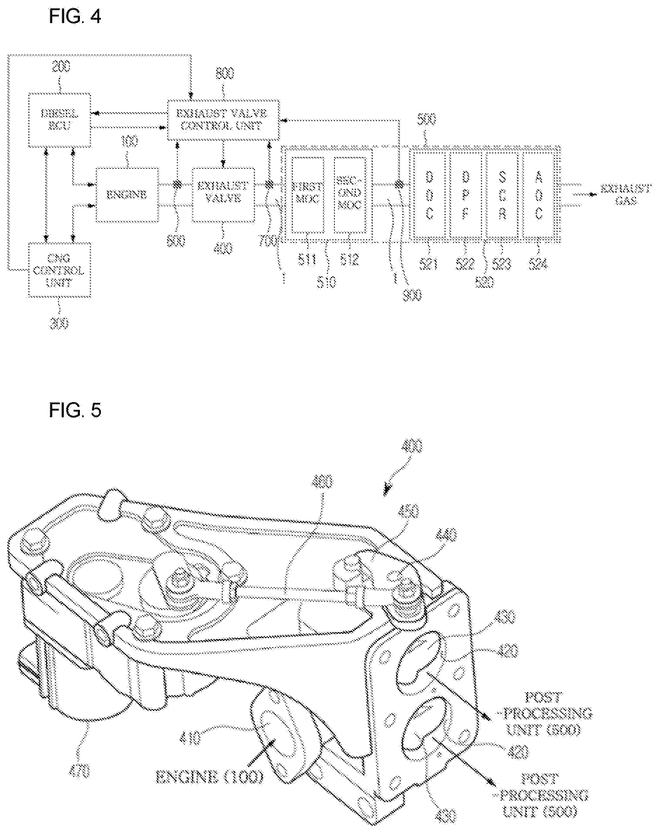

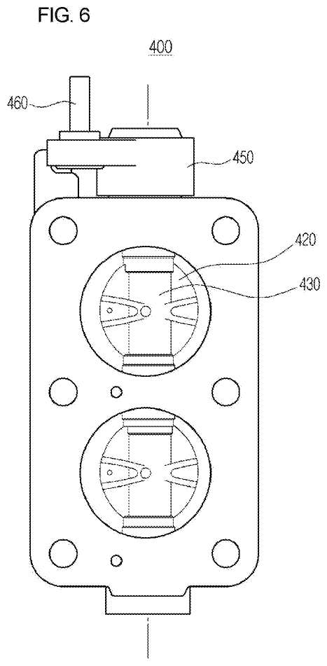

FIGS. 5 and 6 are exemplary views for illustrating the structure of the exhaust valve (400). FIG. 5 is an exemplary perspective view of the exhaust valve (400), and FIG. 6 is an exemplary side view of the exhaust valve (400). In the present invention, the structure of the exhaust valve (400) is not limited to those shown in FIGS. 5 and 6, includes a flap valve disposed in an exhaust gas passage, that is, the pipe (1) between the engine (100) and the post-processing unit (500), in more detail, between the engine (100) and the MOC (510), and a motor that opens/closes the flap valve, and may include various types of structure that allows or stops exhaust gas produced by the engine (100) to be supplied or from being supplied to the MOC (510), depending on the state of the flap valve.

Referring to FIGS. 5 and 6, the exhaust valve (400) has an exhaust gas intake port (410) into which the exhaust gas produced by the engine (100) flows and an exhaust gas discharge port (420) for supplying exhaust gas to the post-processing unit (500) through the pipe (1). Two exhaust gas discharge port (420) may be provided, and one or more may be provided.

The flap valve (430) is rotatably disposed on the pipe (1) to open/close the exhaust gas discharge port (420), and a valve shaft (440) is fitted through the flap valve (430) to be able to integrally rotate.

An end of the valve shaft (440) is fitted through a lever (450) to be integrally connected, and an operation rod (460) is connected to a side of the lever (450) to operate together.

The operation rod (460) is connected with an actuator (470) to be able to receive an operation force from the actuator (470).

That is, when the actuator (470) is operated in response to a valve control signal from the exhaust valve control unit (800), the operation rod (460) is rotated by the actuator (470) and rotation of the operation rod (460) is transmitted as it is to the lever (450), whereby the lever (450) is rotated.

The valve shaft (440) is integrally rotated by rotation of the lever (450), and the flap valve (430) is also rotated by rotation of the valve shaft (440), whereby the exhaust gas discharge port (420) is opened/closed.

Referring back to FIG. 4, the post-processing unit (500) reduces and discharges noxious substances in the exhaust gas flowing from the engine (100) through the pipe (1) when the exhaust valve (400) is opened.

The post-processing unit (500) includes a MOC (510) and an integral processing unit (520). The MOC (510) and the integral processing unit (520) are spaced at a predetermine distance or more apart from each other through the pipe (1).

The MOC (510), which is a part for oxidizing CH₄ contained in exhaust gas, may be composed of a first MOC (511) and a second MOC (512) sequentially disposed behind the engine (100), and may be preferably disposed closest to the engine (100) to minimize reduction of temperature of exhaust gas.

The main function of the first MOC (511) is to increase the temperature of the exhaust gas to a predetermined level by reacting with exhaust gas flowing in from the engine (100), and to supply the exhaust gas to the second MOC (512). The main function of the second MOC (512) is to reduce CH₄ contained in exhaust gas to satisfy regulations.

The main purpose of the first MOC (511) is to supply exhaust gas to the second MOC (512) with the temperature of the exhaust gas stably maintained at a predetermined level, so the material or the ratio of Pt:Pb thereof is set in consideration of the purpose of increasing the output temperature of exhaust gas and it has a smaller size than the second MOC (512).

That is, CH₄, which is a compound having a very stable structure, is characterized by requiring very large active energy for cutting C—H boding for oxidation. CH₄ has a self-ignition temperature of 537° C. and cannot be self-ignited except for a high-load period in an exhaust gas temperature range of CNG-diesel engine. Accordingly, in order to reduce CH₄, the present invention includes the MOC (methane oxidation catalyst) and lowers the self-ignition temperature of CH₄ through the MOC (510) such that CH₄ can be removed in the exhaust temperature range of a dual fuel engine.

The integral processing unit (520) includes a DOC (diesel oxidation catalyst) (521), a DPF (diesel particulate filter) (522), an SCR (selective catalyst reduction) (523), and an AOC (524).

The DOC (521), which is a device that processes exhaust gas through oxidation using a catalyst including white gold such as platinum, palladium, and rhodium, performs a function that reduces smoke, CO, and HC concentration.

The DPF (511) collects and filters out particulate matters (PM) such as hydrocarbon residue, which is produced due to incomplete combustion of diesel in exhaust gas, through a filter and then burns and removes them at high temperature of 550° C.

The SCR (523) reduces carbon monoxide that is produced in a large amount by an engine, in addition to nitrogen oxides (NOx).

The AOC (524) performs a function that oxidizes ammonia of exhaust gas.

The first temperature sensor (600) is disposed ahead of the exhaust valve (400) and measures the temperature of the exhaust gas produced by the engine (100). The first temperature sensor (600) may be disposed around the intake port (410).

The second sensor (700) is disposed behind the exhaust valve (400) and measures the temperature of the exhaust gas flowing into the post-processing unit (500), in more detail, the MOC (510). The second temperature sensor (700) may be disposed around the discharge port (420).

The exhaust valve control unit (800) adjusts and decreases the opening angle of the exhaust valve (400) on the basis of output end exhaust temperature provided from the second sensor (700) and controls and increases the opening angle of the exhaust (400) on the basis of the input end exhaust temperature provided from the first sensor (600).

Further, a reference input temperature and a reference output temperature may be set differently in correspondence to the engine load rate, and the exhaust valve control unit (800) can discharge exhaust gas to the MOC (510) after adjusting the temperature of the exhaust gas by controlling operation of the exhaust valve (400), in more detail, the flap valve (430) disposed at the discharge port (420) on the basis of the reference input temperature and the reference output temperature pre-set on the basis of the engine load rate provided from the diesel ECU (200).

That is, the exhaust valve control unit (800) controls the exhaust valve (400) such that the exhaust gas flowing into the MOC (510) maintains temperature at 400° C. or higher.

Further, a third temperature sensor (900) for measuring the temperature of the exhaust gas flowing into the integral processing unit (520) may be additionally provided ahead of the integral processing unit (520) in the present invention.

The third temperature sensor (900) may have been installed in a diesel vehicle before the dual fuel system is mounted. That is, a diesel vehicle equipped with the dual fuel system can monitor whether the exhaust gas flowing in to the integral processing unit (520) maintains a predetermined temperature range through the third temperature sensor (900), and when the temperature of the exhaust gas is out of the predetermined temperature range, it can make a driver recognize the fact by generating a warning etc.

Accordingly, in the present invention, the exhaust valve control unit (800) is disposed and electrically connected between signal lines between the diesel ECU (200) and the third temperature sensor (900), and when temperature measured to be over a predetermined temperature range is input from the third temperature sensor (900), the exhaust valve control unit (800) can set again the measured temperature of the third temperature sensor (900) to the predetermined temperature and transmits to the diesel ECU (200).

This is for preventing a warning from being generated due to an increase in temperature of the exhaust gas flowing into the integral processing unit (520) by controlling the temperature of the exhaust gas in a co-firing mode.

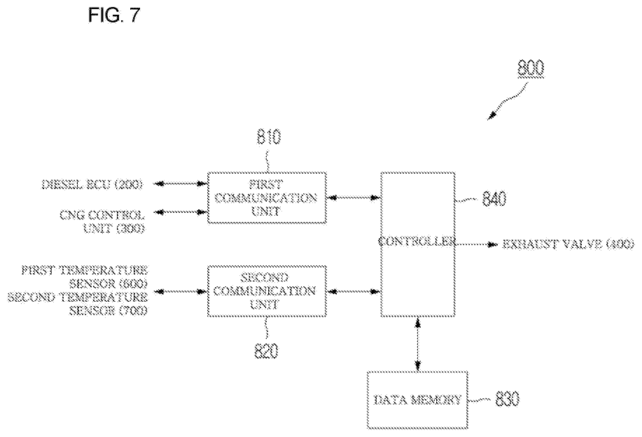

FIG. 7 is a block configuration diagram separately showing the inner components of the exhaust valve control unit (800) shown in FIG. 4 in accordance with functions.

Referring to FIG. 7, the exhaust valve control unit (800) includes first and second communication units (810 and 820), a data memory (8300, and a controller (840).

The first communication unit (810), which transmits/receives fuel engine supply-related information and engine state information to/from the diesel ECU (200), performs CAN (controller area network) communication.

The second communication unit (820), which is connected with the first and second sensors (600 and 700), collects exhaust gas temperature at the input end and the output end of the exhaust valve (400) and transmits it to the controller (840).

The data memory (830) keeps various items of information for controlling the exhaust valve, including the reference input temperature and reference output temperature of exhaust gas and exhaust valve control information for each temperature difference. The movement angle, the reference input temperature and reference output temperature of exhaust gas, and the exhaust valve control information for each temperature difference may be set differently in correspondence to the engine load rate and stored in a table. Further, the movement angle, the reference input temperature and reference output temperature of exhaust gas, and the exhaust valve control information for each temperature difference may be set differently and stored for a diesel mode and a co-burning mode.

The controller (840) monitors the output end exhaust temperature provided from the second temperature sensor (700) in the co-burning mode after the engine of the vehicle is started and decreases the opening angle of the exhaust valve (400) (closing mode) when the output end exhaust temperature becomes less than a predetermined reference output temperature of 400° C. Thereafter, when the input end exhaust temperature provided from the first sensor (600) becomes a predetermined reference input temperature 500° C. or higher, the controller (840) increases the opening angle of the exhaust valve (400) (opening mode).

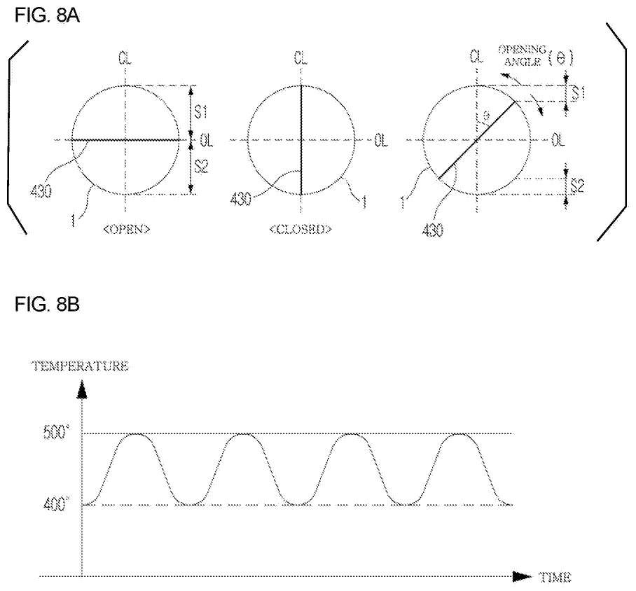

That is, the controller (840), as shown in FIG. 8A, increases an open space (S1+S2) that is an exhaust gas discharge passage of the pipe (1) by increasing the opening angle (θ) of the flap valve (430) when the input end exhaust temperature is the predetermined reference temperature or higher, and decreases the open space (S1+S2) that is the exhaust gas discharge passage of the pipe (1) by decreasing the opening angle (θ) of the flap valve (430) when the output end exhaust temperature is less than the predetermined reference output temperature such that the temperature of the exhaust gas flowing into the MOC (510) increases. Accordingly, when the engine (100) of the vehicle is started and the open space formed in the pipe (1) is decreased by adjusting the position of the flap valve (430) with exhaust gas being continuously discharged from the engine (100), the exhaust gas discharged from the engine (100) cannot all flow into the MOC (510) and stagnated ahead of the flap valve (430) to be increased in pressure, whereby the temperature of the exhaust gas is increased.

The opening angle (θ) is the angle between the flap valve (430) and a closed line (CL). An open line (OL) can be set horizontally to the pipe (1) when the flap valve (430) is fully open, and a closed line (CL) can be set perpendicularly to the pipe (1) when the flap valve (430) is fully closed.

The reference input temperature is set higher than the reference output temperature. For example, the reference input temperature may be set at 500° C. or more and the reference output temperature may be set at 400° C. or less. In this case, the temperature of the exhaust gas flowing into the MOC (510) can be maintained in the range of 400° C.˜500° C., as shown in FIG. 8B.

When the fuel supply mode is the diesel mode, the controller (840) can control opening/closing of the exhaust valve (400) on the basis of a valve control signal provided from the diesel ECU (200). The controller (840) can determine whether it is the diesel mode or the co-firing mode on the basis of the CNG spray information provided from the CNG control unit (300). For example, it is possible to determine that it is the co-firing mode when the CNG spray information is received, and that it is the diesel mode when the CNG spray information is not received.

The controller (840) can adjust the opening angle of the exhaust valve (400) based on the exhaust temperature at the input end and the output end of the exhaust valve (400) only when the fuel supply mode is the co-firing mode.

Further, when the engine load rate provided from the diesel ECU (200) is a predetermined level or more, the controller (840) can adjust the opening angle of the exhaust valve (400) on the basis of a valve control signal provided from the diesel ECU (200), as in the diesel mode. The controller (840) can adjust the opening angle of the exhaust valve (400) on the basis of a valve control signal provided from the diesel ECU (200) only when a predetermined time passes after the engine of the vehicle is started, and the engine load rate is a predetermined level or more. The valve control signal includes valve position control information corresponding to the opening angle of the valve. Further, the controller (840) can set the position of the flap valve (430) by controlling the motor of the exhaust valve (400) to have an opening angle corresponding to the position control information.

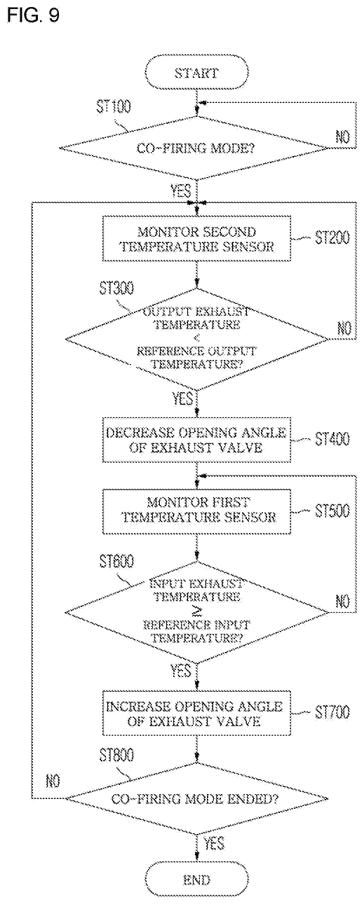

Next, a method of reducing THC in a CNG-diesel dual fuel engine system according to the present invention is described with reference to FIG. 9. The following description is based on the operation of the exhaust valve control unit (800).

First, the exhaust valve control unit (800) determines whether the fuel supply module changes into the co-firing mode with the engine of the vehicle in operation (ST100). The controller (800) can determine whether it is the co-firing mode on the basis of the CNG spray information provided from the CNG control unit (300).

The exhaust valve control unit (800) monitors input exhaust temperature before the exhaust valve provided from the first temperature sensor (600) when it changes into the co-firing mode (ST200). The exhaust valve control unit (800) can monitor the input exhaust temperature of the first temperature sensor (600) when receiving a valve control signal corresponding to opening of the exhaust valve from the diesel ECU (200) with the exhaust valve (400) closed.

The exhaust valve control unit (800) determines whether the output exhaust temperature provided from the second temperature sensor (700) is less than a predetermined reference output temperature (ST300).

The exhaust valve control unit (800) maintains the opening angle of the exhaust valve (400) when the output exhaust temperature provided from the second temperature sensor (700) in step ST300 is the predetermined reference output temperature or higher.

On the other hand, the exhaust valve control unit (800) changes the state of the exhaust valve (400) such that the opening angle of the exhaust valve (400) decreases when the output exhaust temperature provided from the second temperature sensor (700) in step ST300 is less than a reference output temperature (ST400). Accordingly, the exhaust gas produced by combustion of fuel in the engine (100) increases in temperature and flows into the MOC (510).

The exhaust gas flowing in the MOC (510) is sent to the integral processing unit (520) with CH₄ reduced through oxidation, and exhaust gas is discharged with noxious substance including NOx reduced through the integral processing unit.

Further, the exhaust valve control unit (800) decreases the opening angle of the exhaust valve (400) and then monitors the input exhaust temperature before the exhaust valve (400) provided from the first temperature sensor (600) (ST500).

The exhaust valve control unit (800) determines whether the input exhaust temperature provided from the first temperature sensor (600) is a predetermined reference output temperature or higher (ST600).

The exhaust valve control unit (800) maintains the opening state of the exhaust valve (400) when the input exhaust temperature provided from the first temperature sensor (600) in step ST500 is less than the predetermined reference input temperature.

On the other hand, the exhaust valve control unit (800) changes the state of the exhaust valve (400) such that the opening angle of the exhaust valve (400) increases when the input exhaust temperature provided from the first temperature sensor (600) in step ST500 is a reference input temperature or higher (ST700). That is, the pipe space for discharging from the engine (100) to the post-processing unit (500) is enlarged, so the temperature of the exhaust gas flowing into the MOC (510) may be decreased in the same condition.

Thereafter, the exhaust valve control unit (800) repeats the operation described above until the co-firing mode is ended. That is, the exhaust valve control unit (800) repeats the operation of controlling the exhaust valve to increase the opening angle of the exhaust valve (400) by monitoring the input temperature of the first temperature sensor (600) with the opening angle of the exhaust valve (400) decreased by the output temperature of the second temperature sensor (700), and the operation of monitoring the output temperature of the second temperature sensor (700) with the opening angle of the exhaust valve increased by the first temperature sensor (600).

Meanwhile, the exhaust valve control unit (800) performs the operation of adjusting the opening angle of the exhaust valve (400) on the basis of the input end temperature and the output end temperature of the exhaust valve from the point in time of starting the co-firing mode to the point in time of ending the co-firing mode in the embodiment described above. However, controlling the opening angle of the exhaust valve (400) on the basis of the input end temperature and the output end temperature of the exhaust valve (400) may be performed only when the engine load rate is less than a predetermined level or only from the point in time of starting the engine of the vehicle to the point in time of stopping the engine, and may be performed only under the condition of a combination thereof. For example, it can be performed only when it is the co-firing mode and the engine load rate is less than a predetermined level.

According to the present invention, it can reduce and discharge the THC contained in exhaust gas to satisfy EURO 6 through the improvement of the reaction rate of THC in the MOC even in a low-temperature low-load period by sending exhaust gas from an engine into the MOC with the temperature of the exhaust gas maintained at a predetermined level or higher in order to reduce noxious substances, particularly, total hydrocarbon contained in the exhaust gas.

While the present invention has been described with respect to the specific embodiments, it will be apparent to those skilled in the art that various changes and modifications may be made without departing from the spirit and scope of the invention as defined in the following claims.

What is claimed is:

1. A device for THC reducing of exhaust gas in CNG-diesel dual fuel engine system that enables CNG (Compressed Natural Gas) and diesel to be used as fuel of a diesel engine by co-firing them in a diesel vehicle equipped with a CNG supply unit for an aftermarket, the device comprising:
an engine providing power for the diesel and outputting exhaust gas due to operation;
a MOC (Methane Oxidation Catalyst) oxidizing and discharging CH₄ contained in exhaust gas discharged from the engine;
an exhaust valve disposed in a pipe connecting the rear end of the engine and the front end of the MOC, and discharging the exhaust gas produced by the engine;
a first temperature sensor disposed at the front end of the exhaust valve and measuring the temperature of exhaust gas coming from the engine;
a second temperature sensor disposed at the rear end of the exhaust valve and measuring the exhaust gas discharged from the exhaust valve and flowing into the MOC; and
an exhaust valve control unit increasing the temperature of exhaust gas flowing into the MOC by decreasing an opening angle of the exhaust valve such that an exhaust gas discharge passage of the pipe is narrowed when output temperature of the second temperature sensor is less than a predetermined reference output temperature by monitoring the output temperature with exhaust gas being discharged from the engine after the engine is started; and enlarging the exhaust gas discharge passage of the pipe by increasing the opening angle of the exhaust valve when input temperature of the first temperature sensor is a predetermined reference input temperature or higher by monitoring the input temperature.

2. The device of claim 1, wherein when the engine of the vehicle is started, the exhaust valve control unit first repeats monitoring output temperature of the second temperature sensor, controlling the exhaust valve to increase the opening angle of the exhaust valve by monitoring input temperature of the first temperature sensor with the opening angle of the exhaust valve decreased in accordance with output temperature of the second temperature sensor, and monitoring output temperature of the second temperature sensor with the opening angle of the exhaust valve increased by the first temperature.

3. The device of claim 1, wherein the reference input temperature is set higher than the reference output temperature, and
the exhaust valve controller adjusts the opening angle of the exhaust valve such that exhaust gas with a temperature of 400° C. or higher flows into a post-processing unit.

4. The device of claim 1, wherein the MOC is composed of a first MOC and a second MOC sequentially disposed behind the engine,
the first MOC increases exhaust gas in temperature using reaction with CH₄ contained in exhaust gas discharged from the engine and outputs to the second MOC, and
the second MOC performs a function that reduces CH₄ contained in exhaust gas to satisfy regulations.

5. The device of claim 1, wherein an integral processing unit that reduces noxious substances contained in exhaust gas and discharges the exhaust gas is disposed behind the MOC and a third temperature sensor measuring the temperature of exhaust gas flowing into the integral processing unit is additionally disposed ahead of the integral processing unit, and
the exhaust valve control unit transmits temperature information provided from the third temperature sensor while controlling the opening angle of the exhaust valve on the basis of monitoring the first temperature sensor and the second temperature sensor, and transmits temperature information within a predetermined reference temperature range to a diesel ECU when the temperature provided from the third temperature sensor is the reference temperature range or higher.

6. The device of claim 4, wherein an integral processing unit that reduces noxious substances contained in exhaust gas and discharges the exhaust gas is disposed behind the MOC and a third temperature sensor measuring the temperature of exhaust gas flowing into the integral processing unit is additionally disposed ahead of the integral processing unit, and
the exhaust valve control unit transmits temperature information provided from the third temperature sensor while controlling the opening angle of the exhaust valve on the basis of monitoring the first temperature sensor and the second temperature sensor, and transmits temperature information within a predetermined reference temperature range to a diesel ECU when the temperature provided from the third temperature sensor is the reference temperature range or higher.

7. The device of claim 1, wherein the exhaust valve control unit receives engine load rate information by communicating with a diesel ECU (electronic control unit), and controls the opening angle of the exhaust valve on the basis of monitoring the first temperature sensor and the second temperature sensor only when the engine load rate is less than a predetermined reference level.

8. The device of claim 1, comprising a CNG control unit controlling CNG spray from the engine and transmitting CNG spray information to the exhaust valve control unit,
wherein the exhaust valve control unit controls the opening angle of the exhaust valve on the basis of monitoring the first temperature sensor and the second temperature sensor only when determining that it is a co-firing mode on the basis of the CNG spray information provided from the CNG control unit.

9. The device of claim 1, wherein the exhaust valve control unit monitors input temperature of the first temperature sensor when receiving a valve opening signal from the diesel ECU with the exhaust valve closed, and monitors output temperature of the second temperature sensor when receiving a valve closing signal from the diesel ECU with the exhaust valve open.

10. The device of claim 1, wherein the exhaust valve control unit differently sets a reference input temperature and a reference output temperature in diesel mode and a co-firing mode, and controls the exhaust valve on the basis of the predetermined reference input temperature and the reference output temperature in correspondence to the operation mode received by communicating with the diesel ECU.

11. The device of claim 1, wherein the exhaust valve includes a flap valve disposed in a pipe between the engine and the MOC, and a motor adjusting the position of the flap valve, and adjusts the temperature of exhaust gas by adjusting the amount of exhaust gas supplied to the MOC through the pipe in accordance with the position of the flap valve.
